(19) United States
(12) Patent Application Publication
(10) Pub. No.: US 2016/0332410 A1
(43) Pub. Date: Nov. 17, 2016

(54) PRODUCTION METHOD FOR A CORE OF POLYMER SANDWICH STRUCTURAL MATERIAL, CORE AND MATERIAL

(71) Applicants: Alexis CHERMANT, Auberville (FR); Frédéric BRUN, Caen (FR)

(72) Inventor: Frederic BRUN, CAEN (FR)

(21) Appl. No.: 15/111,845

(22) PCT Filed: Jan. 14, 2015
(86) PCT No.: PCT/FR2015/050083

§ 371 Date: Jul. 15, 2016

(30) Foreign Application Priority Data
Jan. 15, 2014 (FR) 1450309

(51) Int. Cl. B32B 3/12; B32B 5/26; B32B 38/18; B32B 37/12; B32B 37/10; B32B 7/14; B32B 38/00

(52) U.S. Cl. CPC B32B 3/12; B32B 7/14; B32B 5/26; B32B 38/0012; B32B 37/1292; B32B 37/10; B32B 38/1808; B32B 38/0004; B32B 2250/20; B32B 2260/023; B32B 2038/0028; B32B 2250/40

(57) ABSTRACT

A core of polymer sandwich structural material (1) includes a resined cellular structure (31) with one first and one second polymer fabric sheets (8, 9) adhering in the area of an adhesive strip (17). A unit (5) includes a corrugated unit portion (12) on at least one surface (6) thereof, on which a resin is disposed and cross-linked. A production method for such a core of polymer sandwich structural material is also described.

The present invention relates to methods for implementation of course of polymer sandwich structural material, to the cores of polymer sandwich structural material resulting from such methods and to structural materials comprising such a core.

Sandwich structural materials are generally composed of 2 rigidly connected outer skins on opposite surfaces of a core. Said core is made such that it has a high structural strength in compression and bending while retaining a minimal weight. These structural materials have many applications, for example in the domain of aeronautics and automobiles.

Among these materials, the best-known are those comprising a honeycomb core. These cores are made up of sheets shaped and attached together at precise points in order to form a network of hexagonal profile cells, sometimes deformed, which extend perpendicularly to said outer skins.

### TECHNOLOGICAL BACKGROUND

From the U.S. Pat. No. 5,431,980 structural material cores are known which can be used in order to create walls that are both rigid, light and curved.

In order to do this, the document calls in particular for a core of structural material which comprises honeycomb shaped cells, where the cells have sides with specific shapes, of the type with corrugated shapes, semicircular patterns, etc.

The cores are implemented from corrugated strips superimposed on each other and connected pointwise to each other by attachment zones. The corrugated strips have a repeated motif on the full-length thereof and this motif includes a flat area alternating with a corrugated area. The flat areas of each corrugated strip are alternately attached either to a flat area of an upper corrugated strip or to a flat area of a lower corrugated strip. Additionally, the material core is deployable between a compact state and a deployed state by expansion of the superposed corrugated strips in a direction perpendicular to the direction of said superposed corrugated strips.

Said core can be implemented in a wide variety of constituent materials including for example metals like aluminum.

Advantageously, such a core can be implemented in nonmetal materials like polymer materials. The fire resistance can be increased and the release of toxic smoke can be reduced in this way. Also in this way, the cost of the structure can be reduced, the production method can be simplified and the resulting mechanical properties can be optimally controlled.

### SUBJECT OF THE INVENTION

The objective of the invention is to propose a core of polymer sandwich structural material having in particular improved mechanical properties, reduced density and/or reduced cost.

For this purpose, the first objective of the invention is a production method for a core of polymer sandwich structural material comprising the following steps:

Providing at least one first polymer fabric sheet and one second polymer fabric sheet extending respectively substantially in extension directions, where one sheet among the first and second sheets comprises at least one corrugated sheet portion in a sheet thickness direction substantially perpendicular to the extension direction and where one sheet among the first and second sheets comprises at least one adhesive strip;

Superimposing the first and second sheets in the sheet thickness direction to obtain a sandwich of sheets;

Pressing the sandwich of sheets in the sheet thickness direction such that the sheets adhere to each other in the area of the adhesive strip;

Stretching the sandwich of sheets in the sheet thickness direction in order to form a cellular structure comprising at least one unit, where said unit is provided with a corrugated unit portion on at least one surface;

Until obtaining a core of polymer sandwich structural material with a density included in a predefined density range, repeating the operations of:

Disposing a resin at least on the corrugated unit portion of the cellular structure; and

Crosslinking the resin in order to obtain a resined cellular structure.

In preferred embodiments of the invention, one and/or another of the following dispositions could be used:

The step of providing at least one first polymer fabric sheet and one second polymer fabric sheet comprises:

Providing a strip of polymer fabric extending substantially in the extension directions;

Deforming at least one portion of the polymer fabric strip in a sheet thickness direction substantially perpendicular to the extension directions, so as to obtain a corrugated strip portion;

Disposing at least one adhesive strip on the polymer fabric strip;

Cutting the strip in order to form at least one first and one second polymer fabric sheets extending respectively substantially in the extension directions, where at least one sheet among the first and second sheets comprises the corrugated strip portion and where at least one sheet among the first and second sheets comprises the adhesive strips;

The first and the second polymer fabric sheets respectively comprise a first corrugated sheet portion and a second corrugated sheet portion; and

The first and second sheets are superposed in order to obtain a sandwich of sheets so as to dispose the first and second corrugated sheet portions opposite each other;

The step of pressing the sandwich of sheets comprises heating of the sandwich of sheets in order to activate the adhesive strip;

The step of stretching the sandwich of sheets in order to form a cellular structure comprises a step of curing the cellular structure at temperature over a vitreous transition temperature of the polymer fabric in order to obtain an adhesive self-supporting structure;

In order to dispose a resin at least on the corrugated unit portion of the cellular structure, the cellular structure is dipped into a resin bath.

An objective of the invention is also a core of polymer sandwich structural material extending substantially in the core extension directions and being intended to be included between an upper surface and a lower surface, opposite in a core thickness direction, where said core includes a resined cellular structure comprising at least one unit;

Said cellular structure comprises a sandwich of sheets, stretched in a sheet thickness direction, comprising at least one first polymer fabric sheet and one second polymer fabric sheet extending respectively substantially in extension directions, substantially perpendicular to the sheet thickness direction, where the first and second sheet adhere to each other in the area of at least one adhesive strip;

A resin is disposed and cross-linked at least on said unit of the cellular structure.

One sheet among the first and second polymer fabric sheets comprises at least one corrugated sheet portion, deformed in the sheet thickness direction;

Said at least one unit is provided with a corrugated unit portion on at least one surface; and

The resin is disposed and cross-linked at least on the corrugated unit portion of the cellular structure.

In preferred embodiments of the invention, one and/or another of the following dispositions could be used:

One sheet among the first and second polymer fabric sheets comprises an adhesive strip in the area of a corrugated sheet portion;

the corrugated sheet portion and the corrugated unit portion comprise a plurality of raised motifs, where each raised motif of the corrugated sheet portion extends substantially out of the extension plane formed by the sheet extension directions;

The corrugated sheet portion has a general zigzag shape comprising at least 2 sheet humps;

Said at least two humps each have a pointed summit.

Finally an objective of the invention is a sandwich structural material comprising a core such as described above and also at least one outer skin attached to said core.

### BRIEF DESCRIPTION OF THE DRAWINGS

In order to be able to be executed, the invention is disclosed sufficiently clearly and completely in the following description which is, additionally, accompanied by drawings in which:

FIG. 1 partially shows a structural material core seen in perspective and substantially from above;

FIG. 2 shows a detail of a structural material core according to the invention in frontal view and showing in particular a unit;

FIG. 3 shows the steps of supplying the strip, deformation of the strip and depositing adhesive from a production method for a core of polymer sandwich structural material;

FIG. 4 shows a detail of the step of deformation of the strip from FIG. 3;

FIG. 5 shows a detail of the step of depositing adhesive from FIG. 3;

FIG. 6 shows the steps from a production method for a core of polymer sandwich structural material of cutting of the strip, superposition of the sheets, pressing of the sandwich of sheets, stretching the same which is sheets, depositing resin and cross-linking the resin;

FIG. 7 shows a cellular structure after the step of stretching the sandwich of sheets from FIG. 6; and

FIG. 8 shows a variant of the cellular structure after the step of stretching the sandwich of sheets from FIG. 6.

### DETAILED DESCRIPTION

In the following description, the terms “lower”, “upper”, “top”, “bottom”, etc. are used with reference to the drawings to make understanding easier. They must not be understood as limitations on the scope of the invention.

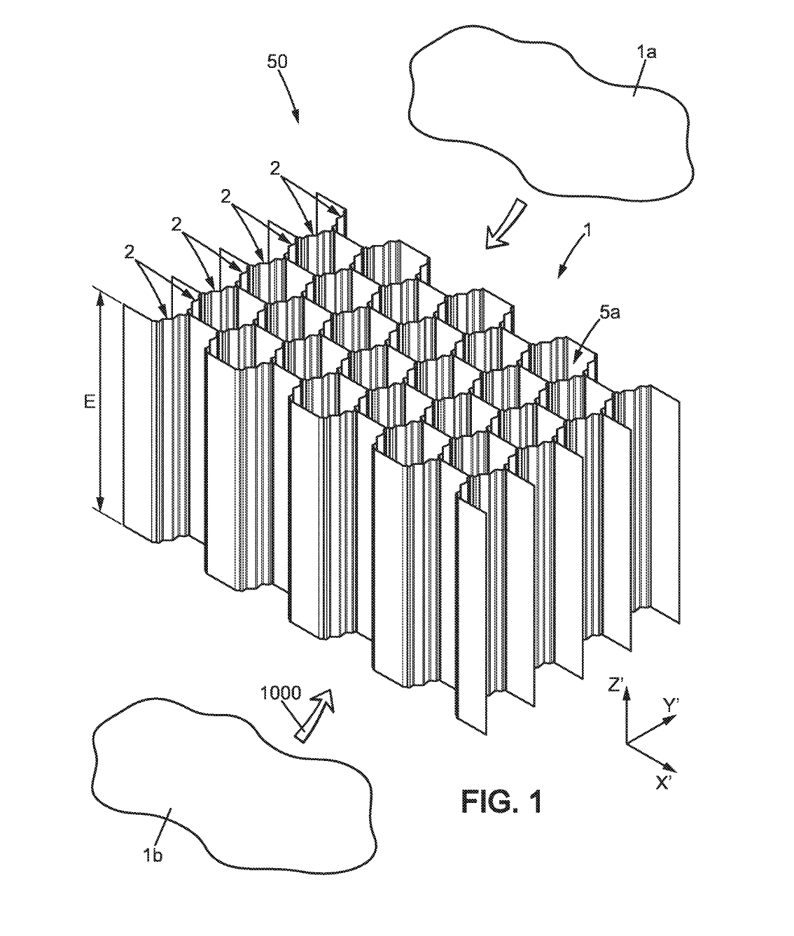

FIG. 1 shows a core 1 conforming to the invention.

The core 1 extends substantially in core extension directions X′, Y′ and is intended to be included between an upper surface 1a and a lower surface 1b, on opposite sides in a core thickness direction Z′, in order to form a sandwich structural material 50.

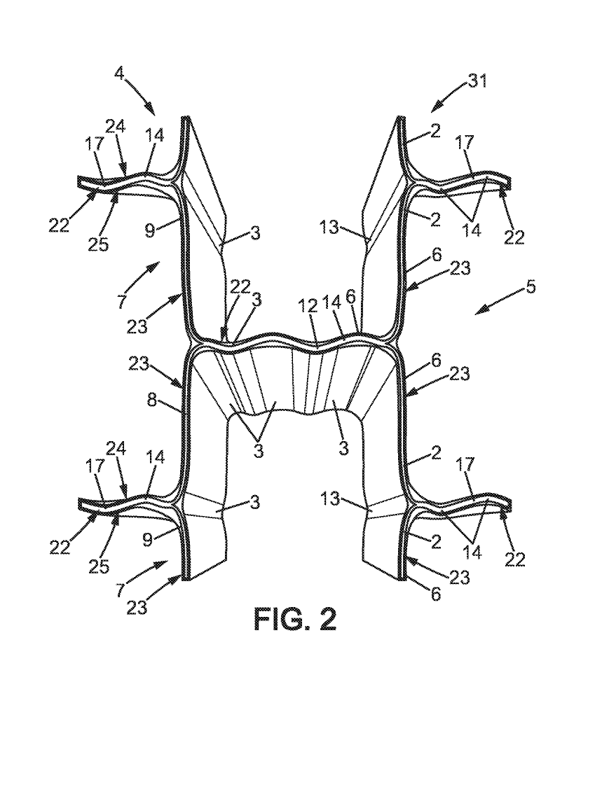

In the production example shown in FIGS. 1 and 2, the core 1 comprises 8 polymer fabric sheets 2 in the form of 2 simple sheets surrounding 3 assemblies of 2 sheets each, which is 8 sheets in total. A structural material core according to the invention is not however limited to the presence of a specific quantity of polymer fabric sheets 2 and according to the desired extension of the core 1 in the extension directions X′ and Y′; the core could comprise more or fewer polymer fabric sheets 2 without departing from the scope of the invention.

The sheets 2 are made of polymer fabric. In particular, the sheets 2 are made from aramid fibers, for example meta-aramid or para-aramid. Such fibers can for example be woven or amalgamated in pulp form in order to form a light and resistant synthetic paper. Such a polymer fabric has in particular “shape memory” properties which are used by the present invention as detailed below.

In order to obtain a resistant core of polymer sandwich structural material 1, the polymer fabric sheets 2 are impregnated with a cured resin 3 so as to obtain a composite material resistant in the 3 spatial dimensions and just the same particularly light.

Now referring more specifically to FIG. 2 which shows a detail of a core 1 of polymer sandwich structural material according to the invention, the core 1 comprises a cellular structure 4 comprising at least one unit 5. Advantageously, the cellular structure 4 comprises a large number of units 5 juxtaposed with each other in the core extension directions X′, Y′ in order to form a periodic network of arbitrary directions.

“unit” is in that way understood to mean for example an elemental link of said periodic network.

“Cellular structure” is understood to mean that the structure 4, although formed of originally planar sheets 2, is a three-dimensional structure where the sheets 2 are assembled and shaped in order to form a structure of arbitrary sizes, mostly composed of empty space between the sheets 2 and just the same having properties of high mechanical strength.

Each unit 5 comprises a plurality of surfaces 6, for example in the case of FIGS. 1 and 2, 5 surfaces 6.

Advantageously, the units 5 can form, once juxtaposed next to each other, a network of hexagonal cells 5a, advantageously a network of regular hexagonal cells 5a.

Here “cell” is in that way understood to mean a three-dimensional structure one section of which has a closed shape, in particular a hexagon, in the case of a cell from honeycomb type network.

The periodic network formed by juxtaposition of units 3 can in that way be a honeycomb type network.

In such a network with hexagonal cells 5a, the units 5 can be juxtaposed in such a manner that each surface 6 of one unit 5 constitutes a surface 6 of 2 adjacent cells 5a.

The cell structures in that way form a compact and strong network, advantageously a honeycomb network.

More precisely, as shown in FIGS. 1 and 2, the cellular structure 4 comprises a sandwich of sheets 7 comprising at least one first polymer fabric sheet 8 and one second polymer fabric sheet 9.

The first and second polymer fabric sheets extend respectively substantially in the extension directions X, Y. They are shaped in a sheet thickness direction Z, substantially perpendicular to the extension directions X, Y, such that the sandwich of sheets is stretched in the sheet thickness direction.

Usually the extension directions X, Y and sheet thickness directions Z are not respectively collinear with the extension directions of the core X′, Y′ and core thickness Z′ but pivoted 90° such that the extension directions X, Y are respectively collinear with a core extension directions X′ and a core thickness direction Z′, whereas the sheet thickness direction Z is co-linear with a core extension direction Y′.

The first and second polymer fabric sheets 8, 9 furthermore adhere to each other in the area of at least one adhesive strip 17.

In the example from FIG. 2, the resin 3 is in particular disposed and cross-linked in the area of the adhesive strip 17.

As can be seen in FIGS. 1, 2 and 8, the core of sandwich structural material 1 is in particular such that the first and second polymer fabric sheets 8, 9 comprise at least one corrugated sheet portion 11, advantageously deformed in the sheet thickness direction Z.

As detailed below, the first and second polymer fabric sheets 8, 9 are shaped in the sheet thickness direction Z and the sheet sandwich 7 is shaped in order to form the cellular structure 4; said corrugated sheet portions 11 then constitute corrugated unit portions 12 disposed on at least one surface 6 of one unit 5.

In that way, the corrugated sheet portion 11 and the corrugated unit portion 12 can comprise a plurality of raised motifs 14 so as to have a general zigzag shape, where the raised motifs 14 advantageously form at least 2 humps.

The resin 3 is for example disposed and cross-linked on the corrugated unit portion 12 of the cellular structure 4.

In this way, the resin 3 forms a plurality of meniscuses 13 on the corrugated unit portion 12 and more specifically a meniscus 13 near each raised motif 14.

The meniscuses 13 serve to stiffen the raised motifs 14 and in that way increase the strength under traction and compression of the core of polymer sandwich structural material 1, in particular in the core extension directions X′ and Y′.

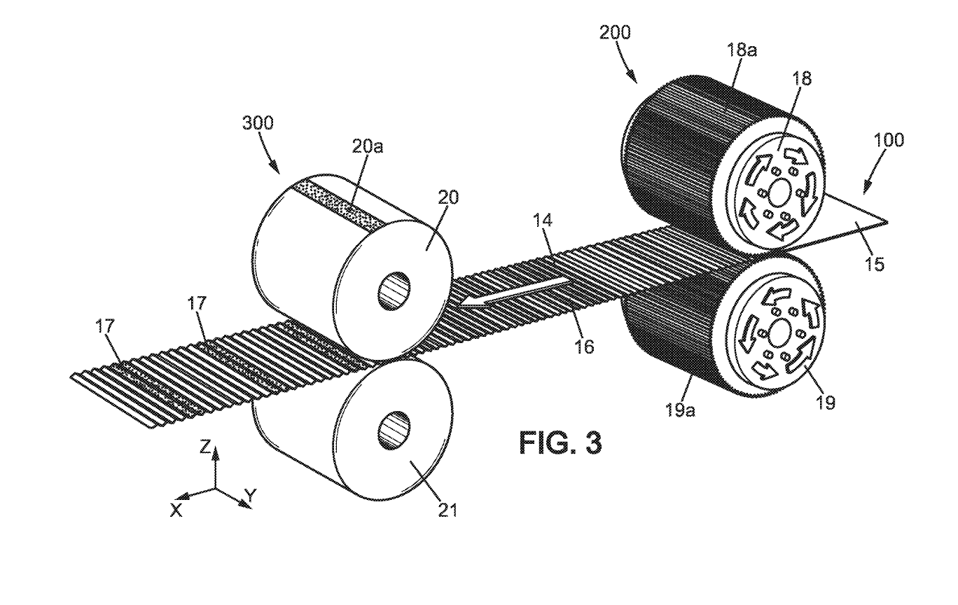

Such a core of sandwich structural material 1 and such a sandwich structural material 50 is now going to be described more specifically with reference to FIGS. 3 to 6.

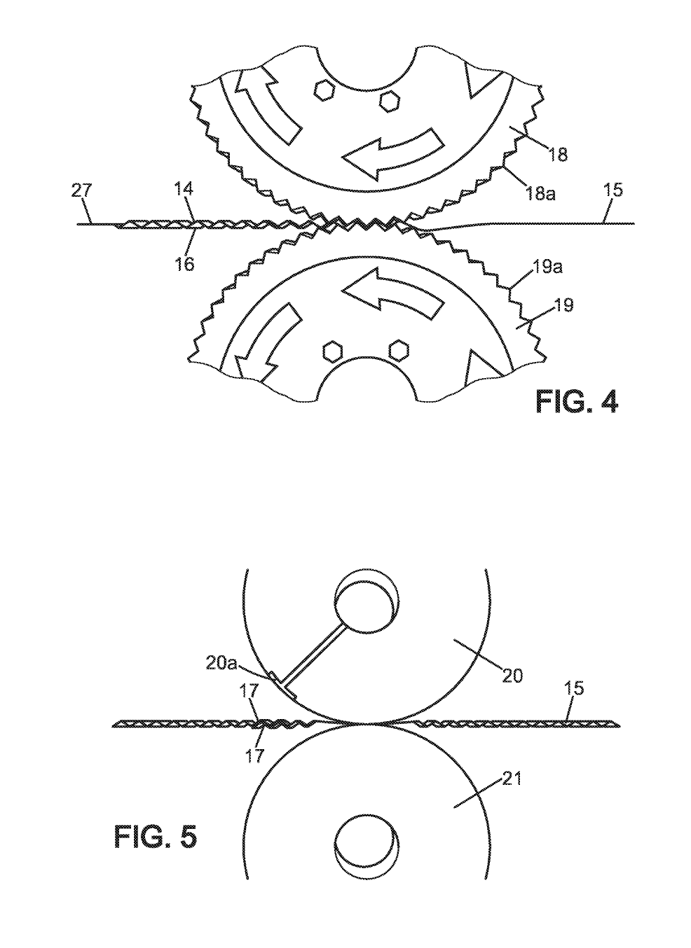

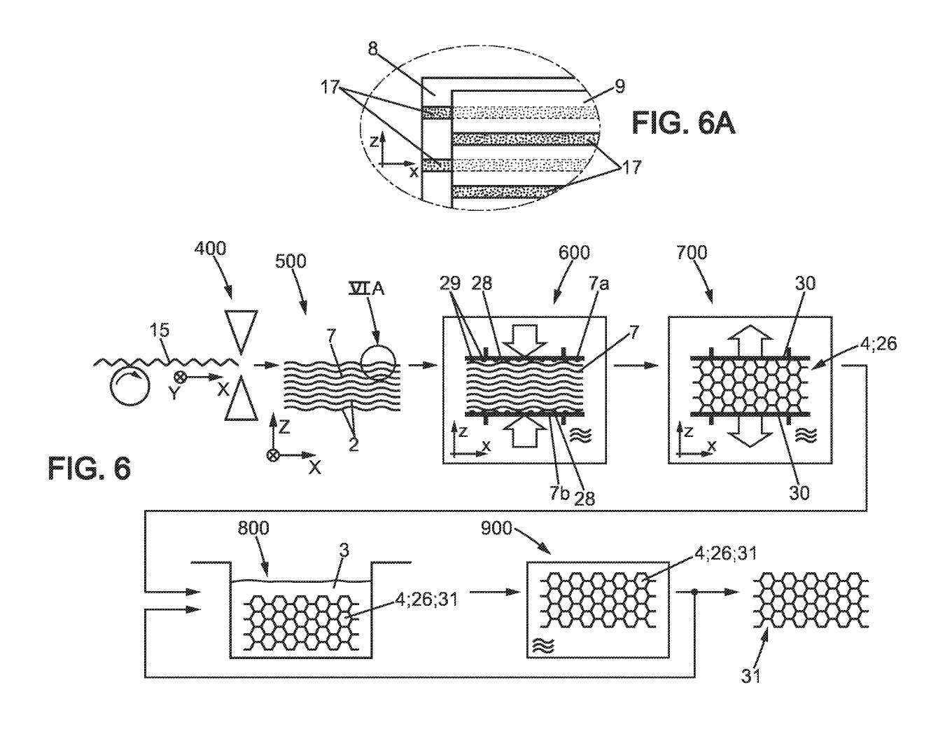

FIG. 3 in relation with FIGS. 4 and 5 shows the first steps of such a method, whereas FIG. 6 in relation with FIGS. 6A, 7 and 8 illustrates the subsequent steps of the method.

As presented in FIG. 3, the method for production of a core of polymer sandwich structural material 1 according to the invention first of all comprises a first step 100 of supplying a polymer fabric strip 15.

More precisely, the polymer fabric strip 15 can extend substantially in the extension directions X, Y comprising one longitudinal extension direction X and one transverse extension direction Y.

The polymer fabric strip 15 can have a defined width, for example substantially equal to the desired thickness E of the core 1 in the transverse extension direction Y, for example included between a few centimeters and a few meters. The polymer fabric strip can additionally have a distinctly longer length in the longitudinal extension direction X, for example from a few meters to several hundreds of meters. The polymer fabric strip 15 can in that way be wound on itself around the transverse extension direction Y, so as to form a roll of polymer fabric strip unwound as needed for production of the core of polymer sandwich structural material 1.

Such a polymer fabric strip 15 is made up of a polymer fabric, for example, of aramid fibers such as described above.

In a second step 200 of deformation of the strip, shown more specifically in FIG. 4, at least one portion of the polymer fabric strip 15 is deformed in the sheet thickness direction Z, substantially perpendicular to the extension directions X, Y. A corrugated strip portion 16 thus results.

As shown in FIG. 4, the polymer fabric strip 15 can, for this purpose, be compressed between 2 shaping rollers 18, 19, whose contact surfaces with the polymer fabrics strip have a plurality of engraved motifs 18a, 19a.

The resulting corrugated strip portion 16 thus has a plurality of raised motifs 14, where each raised motif 14 extends substantially out of the extension plane XY formed by the extension directions X, Y.

Advantageously, the raised motifs 14 are one-dimensional motifs along the transverse extension direction Y. The raised patterns 14 are for example corrugated bands, aligned along the transverse extension direction Y, and have undulations or humps along the longitudinal extension direction X. The raised motives 14 in that way half a general zigzag shape in a section in an XZ plane perpendicular to the transverse extension direction Y.

Alternatively, the raised motifs 14 can be 2 dimensional motifs extending in the longitudinal X and transverse Y extension directions.

As can be seen in FIG. 4, the entirety of the contact surfaces of the shaping rollers 18, 19 with the polymer fabric strip 15 can be covered with engraved motifs 18a, 19a, such that the polymer fabric strip, once pressed between the rollers 18 and 19, is corrugated over the entire longitudinal extension thereof with no remaining smooth portion 27. In this embodiment, the corrugated strip portion 16 thus constitutes the entirety of the polymer fabric strip 15.

In this embodiment, a cellular structure 4 such as shown in FIG. 8 can be obtained, where the entirety of the sheets 2 is corrugated.

Alternatively, the contact surfaces of the shaping rollers 18, 19 with the polymer fabric strip 15 may comprise smooth parts between engraved motifs 18a, 19a, such that the polymer fabric strip 15 has residual smooth parts 27 after pressing between the rollers 18 and 19.

In a 3rd step 300 of depositing adhesive, more specifically shown in FIG. 5, at least one adhesive strip 17 is deposited on the polymer fabric strip 15.

The adhesive strips 17 can for example extend substantially in the transverse extension direction Y.

Preferably, a plurality of adhesive strips 27 are deposited on the polymer fabric strip 15 arranged for example periodically, in particular periodically in the longitudinal extension direction X. For this purpose, the polymer fabric strip 15 can be pressed between 2 adhesive depositing rollers 20, 21.

The contact surface of one or both adhesive depositing rollers 20, 21 can in particular comprise one or more adhesive entries 20a with which to bring adhesive to the area of the contact surfaces of the adhesive depositing rollers 20, 21 with the polymer fabric strip 15.

In an embodiment of the invention, shown in particular in FIGS. 2 and 8, one or more adhesive strips 17 are deposited on one or more corrugated portions of strips 16.

In another embodiment of the invention, shown for example in FIG. 1, adhesive strips 17 can be deposited on residual smooth parts 27 of the polymer fabric strip 15.

Advantageously, the adhesive strips 17 are deposited on the polymer fabric strip 15 once the polymer fabric strip 15 has been deformed (step 200) in order to obtain the corrugated strip portion 16. In fact, because of the shape memory of the polymer fabric, the polymer fabric strip 15 can be crushed between the substantially planar contact surfaces of the 2 adhesive depositing rollers 20 and 21 without the corrugated strip portion 16, shaped during the deformation step 200, disappearing.

Such an arrangement of the steps of the core production method (the step of deposition 300 of the adhesive strip being done subsequent to the deformation step 200) serves furthermore to prevent the deposit of adhesive on the shaping rollers 18, 19 which could occur when the deformation step 200 is done after the deposition step 300.

In a 4th step 400 of cutting the strap, the polymer fabric strip 15 is cut in order to form a plurality of sheets of polymer fabric 2 In particular, a first polymer fabric sheet 8 and a 2nd polymer fabric sheet 9 are formed.

More precisely, the polymer fabric strip 15 is cut such that one sheet at least among the first and second sheets 8, 9 comprises the corrugated strip portions 16 and such that one sheet among the first and second sheets 8, 9 comprises the adhesive strips 17.

For this purpose, as shown in FIG. 6, the polymer fabric strip 15 is cut in the transverse extension direction Y in order to form substantially rectangular polymer fabric sheets 2.

In a 5th step 500 of superposition of the sheets, also shown on FIG. 6, the polymer fabric sheets 2 are superposed on each other in the sheet thickness direction Z in order to obtain the sandwich of sheets 7. In that way, in particular, the first and second sheets 8, 9 are superposed on each other.

More precisely, the first and second sheets 8, 9 can respectively comprise a plurality of adhesive strips 17 extending respectively in the transverse extension direction Y. The first polymer fabric sheet 8 can then be superposed on the second polymer fabric sheet 9 so as to alternate, in the longitudinal extension direction X, adhesive strips 17 respectively from the first and second sheets 8, 9 as shown on the detail of FIG. 6A.

Additionally, the first and the second polymer fabric sheets 8, 9 can respectively comprise a first corrugated sheet portion 24 and a second corrugated sheet portion 25. It is then advantageous to superpose the first polymer fabric sheet 8 on the second polymer fabric sheet 9 so as to arrange the first corrugated sheet portion 24 opposite the second corrugated sheet portion 25. More precisely, the raised motifs 14 of the first and second corrugated sheet portions 24, 25 can be aligned.

Alternatively, the steps of supplying (100), deformation (200), depositing adhesive (300), cutting the strip (400) and superposition (500) described above can be implemented in a different order, by omitting some of these steps and/or adding additional intermediate steps to them.

Therefore as an example, the steps of deformation (200), depositing adhesive (300) and superposition (500) can be implemented directly on precut polymer fabric sheets instead of a polymer fabric strip.

A 6th step 600 of pressing the sandwich of sheets comprises the pressing of the sandwich of sheets 7 in the sheet thickness direction Z. As shown schematically in FIG. 6, the sandwich of sheets 7 can for this purpose be arranged flat in a press suited to compress the sandwich of sheets 7 in the sheet thickness direction Z. This 6th step of the method in that way serves to adhere the adjacent sheets 2 to each other in the area of the adhesive strips 17 in a way that the sandwich of sheets 7 forms a single, rigid structure.

During this step 600, the sandwich of sheets 7 can additionally be heated in particular in order to activate the adhesive strips 17.

In an advantageous embodiment of step 600, the surfaces 28 of the press in contact with the sandwich of sheets 7 can comprise engraved motifs 29 similar to the raised motifs 14 of the sheets 2 of the sandwich of sheets 7. In this way, the pressing step provides for an optimal adhesion of the sheets 2 with each other.

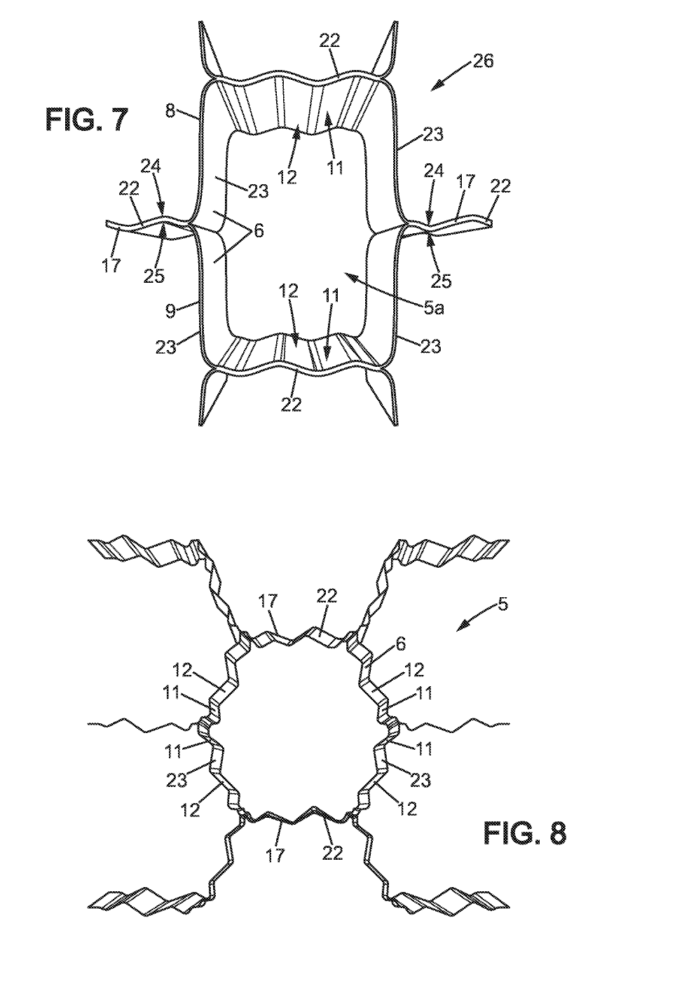

During a 7th step 700 of stretching the sandwich, the sandwich of sheets 7 resulting from the pressing step 600 is stretched in the sheet thickness directions Z in order to form the cellular structure 4 illustrated in FIG. 7.

For that purpose, it is for example possible to attach 2 stretching supports 30, respectively on one upper end 7a and one lower end 7b of the sandwich of sheets 7, that are opposite in the sheet thickness direction Z. The 2 stretching supports 30 are next moved and separated from each other, in the sheet thickness direction Z, so as to separate the upper 7a and lower 7b ends of the sandwich of sheets away from each other in order to stretch said sandwich 7 and form a cellular structure 4.

The resulting cellular structure 4 comprises a plurality of units 5, where each unit 5 comprises a plurality of surfaces 6.

More precisely, as is seen in FIG. 7, the plurality of surfaces 6 can comprise one or more double surfaces 22, where each double surface 22 is made up of 2 sheets 2 bonded together by an adhesive strip 17, for example the first polymer fabric sheet 8 and the second polymer fabric sheet 9. The plurality of surfaces 6 also comprise one or more unique surfaces 23, where each unique surface 23 is made up of a single sheet 2.

Depending on the disposition of the adhesive strips 17, different configurations for the cellular structure 4 can then be obtained.

Thus, in the embodiment shown in FIG. 6, wherein the adhesive strips 17 binding adjacent sheets 2 are alternated in the longitudinal extension direction X, as can be seen in particular in FIG. 6A, the step of stretching 700 is used to obtain a “honeycomb” type cellular structure 4 with substantially hexagonal shaped cells 5a formed by the cellular network 5. In this embodiment each unit 5 comprises 5 surfaces 6, including 4 unique surfaces 23 connected pairwise to each other by a double surface 22.

The cells 5a of the network formed by the units 5 thus have a prism shape comprising a base located in a plane XZ perpendicular to the transverse extension direction Y and extending in said transverse extension direction Y. The cells 5a of the network formed by the units 5 have in particular a hexagonal prism shape in the example from FIGS. 1 and 2.

Depending on the stretching distance, said hexagonal prism can be regular or else be stretched or compressed in the sheet thickness direction Z.

The surfaces 6 of the units 5 do not have to be strictly planar surfaces but can have a general curved shape in particular like the shape shown by the single surfaces 23 of the unit 5 in FIG. 7.

Additionally, the unit 5 comprises a corrugated unit portion 12 corresponding to the corrugated sheet portion 11, after the stretching step 700.

The corrugated unit portion 12 can be located near an adhesive strip 17 joining 2 sheets 2, meaning near a double surface 22, as shown in FIG. 2.

Alternately, the corrugated unit portion 12 can be located outside of the adhesive strips 17, on a single face 23 of the unit 5.

This 7th step of the method 700 can furthermore comprise a curing of the cellular structure 400 with which to obtain a self-supporting cellular structure 26. Such a curing of the cellular structure 4 can for example be done by heating to a temperature over a vitreous transition temperature of the polymer fabric, so as to make said polymer fabric melt and then re-solidify, at least partially. Following such a curing, the cellular structure 4 then adapts the stretched shape as resting shape. Advantageously, the curing of the cellular structure 4 serves to detach the cellular structure 4, made self-supporting, from the stretching supports 30 and therefore to simplify the subsequent steps of the method by increasing the purity and quality of the core 1 obtained in the end.

During an 8th step 800 of depositing resin, shown in FIG. 6, the resin 3 is deposited at least on a corrugated unit portion 12 of the cellular structure 4.

To do that, for example, the cellular structure 4 is dipped in a resin bath 3.

Then, during the 9th step 900 of crosslinking, the resin 3 is cross-linked in order to obtain a resined cellular structure 31. The cross-linking of the resin 3 can be achieved for example by heating and serves to cure the resin 3 deposited on the cellular structure 4.

Thus a resined cellular structure results comprising the cellular structure 4 on which the resin 3 is deposited and cross-linked so as to obtain the desired mechanical properties for the core 1.

The 8th and 9th steps of the method 800, 900 can advantageously be repeated until obtaining a core of polymer sandwich structural material 1 with a density included in a preset density range.

A method for production of a sandwich structural material 50 will advantageously comprise a 10th step 1000 of addition of skin, comprising the addition of an upper surface 27 and/or a lower surface 28 on the core 1, so as in particular to close the openings of the units 5 of the cellular structure.

The upper surface 27 and the lower surface 28 in that way constitute outer skins on the core 1 serving to protect the openings of the cores 5 and therefore to form a strong sandwich structural material 50.

1-12. (canceled)

13. A production method for a core of polymer sandwich structural material, comprising the steps of:
providing at least one first polymer fabric sheet and one second polymer fabric sheet extending respectively substantially in extension directions, where one sheet among the first and second sheets comprises at least one corrugated sheet portion in a sheet thickness direction substantially perpendicular to the extension direction and where one sheet among the first and second sheets comprises at least one adhesive strip;
superimposing the first and second sheets in the sheet thickness direction to obtain a sandwich of sheets;
pressing the sandwich of sheets in the sheet thickness direction such that the sheets adhere to each other in the area of the adhesive strip;
stretching the sandwich of sheets in the sheet thickness direction in order to form a cellular structure comprising at least one unit, where said unit is provided with a corrugated unit portion on at least one surface;
until obtaining a core of polymer sandwich structural material with a density included in a predefined density range, repeating the operations of:
disposing a resin at least on the corrugated unit portion of the cellular structure; and
crosslinking the resin in order to obtain a resined cellular structure.

14. The method according to claim 13, wherein the step of providing at least one first polymer fabric sheet and one second polymer fabric sheet comprises:
providing a polymer fabric strip extending substantially in the extension directions;
deforming at least one portion of the polymer fabric strip in a sheet thickness direction substantially perpendicular to the extension directions, whereby a corrugated strip portion results;
disposing at least one adhesive strip on the polymer fabric strip;
cutting the strip in order to form at least one first and one second polymer fabric sheets extending respectively substantially in the extension directions, where at least one sheet among the first and second sheets comprises the corrugated strip portion and where at least one sheet among the first and second sheets comprises the adhesive strips.

15. The method according to claim 13, wherein the first and the second polymer fabric sheets respectively comprise a first corrugated sheet portion and a second corrugated sheet portion; and
wherein the first and second sheets are superposed in order to obtain a sandwich of sheets so as to dispose the first and second corrugated sheet portions opposite each other.

16. The method according to claim 13, wherein the step of pressing the sandwich of sheets comprises heating of the sandwich of sheets in order to activate the adhesive strip.

17. The method according to claim 13, wherein the step of stretching the sandwich of sheets in order to form a cellular structure comprises a step of curing the cellular structure at temperature over a vitreous transition temperature of the polymer fabric in order to obtain an adhesive self-supporting structure.

18. The method according to claim 13, wherein the cellular structure is dipped into a resin bath in order to dispose a resin at least on the corrugated unit portion of the cellular structure.

19. A core of polymer sandwich structural material extending substantially in the core extension directions and being intended to be included between an upper surface and a lower surface, opposite in a core thickness direction, where said core includes a resined cellular structure comprising at least one unit;
said cellular structure comprises a sandwich of sheets, stretched in a sheet thickness direction, comprising at least one first polymer fabric sheet and one second polymer fabric sheet extending respectively substantially in extension directions, substantially perpendicular to the sheet thickness direction, where the first and second sheet adhere to each other in the area of at least one adhesive strip;
a resin is disposed and cross-linked at least on said unit of the cellular structure;
wherein one sheet among the first and second polymer fabric sheets comprises at least one corrugated sheet portion, deformed in the sheet thickness direction;
said at least one unit is provided with a corrugated unit portion on at least one surface; and
the resin is disposed and cross-linked at least on the corrugated unit portion of the cellular structure.

20. The core according to claim 19, wherein one sheet among the first and second polymer fabric sheets comprises an adhesive strip in the area of a corrugated sheet portion.

21. The core according to claim 19, wherein the corrugated sheet portion and the corrugated unit portion comprise a plurality of raised motifs, where each raised motif of the corrugated sheet portion extends substantially out of the extension plane formed by the extension directions.

22. The core according to claim 19, wherein the corrugated sheet portion has a general zigzag shape comprising at least 2 humps.

23. The core according to claim 22, wherein said at least two humps each have a pointed summit.

24. A structural sandwich material comprising a core according to claim 19 and also at least one outer skin attached to said core.
